(19) United States
(12) Patent Application Publication
(10) Pub. No.: US 2006/0035694 A1
(43) Pub. Date: Feb. 16, 2006

(54) Game including a bonus award funded from a progressive pool and method of determining amount of a bonus award

(76) Inventor: Robert Gary Fuller, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 10/917,584

(22) Filed: Aug. 13, 2004

(51) Int. Cl. G06F 19/00

(52) U.S. Cl. 463/13

(57) ABSTRACT

A game includes the opportunity for a bonus award. As part of the play of a game, such as a game of video poker, one of the possible winning outcomes is selected and designated a bonus winning outcome. If the player receives that outcome as a result of game play, the player is paid a bonus which is larger than the normal payout for that outcome. In one embodiment, at least a portion of the bonus is funded from a progressive pool. Various embodiments of the invention comprise methods of determining a bonus in a game environment where multiple denomination bets may be placed and where a bonus is awarded for outcomes having different probabilities of occurring.

### FIELD OF THE INVENTION

The present invention relates to methods of game play and systems for presenting games.

### BACKGROUND OF THE INVENTION

Gaming, including wager-type gaming, continues to grow in popularity. Game developers continue to seek new and exciting games to attract players and maintain their interest. Many new games are being introduced which use “themes” in order to attract players. These games are essentially old games with respect to their manner of play, with the “themes” adding new excitement to the game.

Other games have been introduced which entice customers with large payouts. For example, IGT's MEGABUCKS® game offers the chance for a player to win millions of dollars, if they receive a particular set of MEGABUCKS symbols on a slot machine when they have placed a maximum bet. Other games offer bonus spins or other events to yield additional winning events to the player.

A need remains for a game which offers excitement of game play, including the opportunity for large winnings.

### SUMMARY OF THE INVENTION

One embodiment of the invention is a method of presenting and playing a game. In the play of the game, one of the possible outcomes of the game is selected as a bonus win combination or category. If the play of the game results in that bonus win combination or category, the player is awarded a bonus win.

In a preferred embodiment, the bonus win combination or category is selected from possible winning outcomes for the game. The bonus win is preferably larger than the normal payout for that winning outcome.

In one embodiment, a bonus pool is configured as a progressive pool and increments or grows based upon wagers placed to play the game. In one embodiment, the wagers may be of multiple denominations and be placed at a plurality of gaming machines. The bonus win amount comprises at least a portion of the bonus pool.

In one embodiment, the game involves the play of video poker. The game has normal winning outcomes comprising various win categories, such as particular poker hands. One of those win categories is selected, as part of the play of each game, to be the bonus win category.

Various embodiments of the invention comprise methods of creating a bonus pool and awarding a bonus win in association with the play of a game or other event. The methods have particular applicability to determining the size of a bonus win in a game play environment where wagers of different values (such as based upon denomination) and winning outcomes having different payouts (and odds of occurring) exist.

In one embodiment, a bonus pool is funded by a portion of wagers placed to play a game. In one embodiment, a portion (such as a percentage) of each wager is allocated to the pool. In another embodiment, the pool is incremented when a player places a wager of a certain size, including a bonus wager.

The bonus win preferably comprises a base award component and a progressive award component which are paid or funded from the bonus pool. In one embodiment, the base award component is comprised of the normal payout for the bonus winning combination when a wager of a single credit or other minimum wager is placed, multiplied by the denomination of the player's wager, preferably multiplied by a multiplier. In one embodiment, the multiplier preferably comprises one less than the number of possible winning outcomes which return more than the player's wager.

In one embodiment, the progressive award component is only included in the bonus award calculation (or is other than a zero value) if the difference between the current bonus pool amount less the base award component is greater than a progressive award threshold for the bonus pool. In one embodiment, if the progressive award component is awarded, it comprises a current value of the bonus pool, less any progressive threshold, less the base award component, multiplied by the ratio of the denomination of the player's wager to the largest possible denomination wager, multiplied by the ratio of the normal single credit or minimum wager pay amount for the selected bonus win category, to the largest possible normal single credit or minimum wager pay amount. In this configuration, the size of the progressive award component is “scaled” based upon the size of the player's wager and the “weight” of the winning outcome (i.e. bonus winning combinations or categories which are statistically more frequently occurring result in smaller bonus win amounts).

The bonus pool may be administered or managed on s single electronic gaming machine, or it can be administered or managed on a central computer system to which a plurality of electronic gaming machines are linked.

Further objects, features, and advantages of the present invention over the prior art will become apparent from the detailed description of the drawings which follows, when considered with the attached figures.

### DESCRIPTION OF THE DRAWINGS

FIG. 1 illustrates a gaming machine configured to implement the game of the present invention;

FIG. 2 illustrates a paytable for a game in accordance with the present invention;

FIG. 3(a) illustrates a set of dealt cards in accordance with play of a game in accordance with an embodiment of the invention;

FIG. 3(b) illustrates the hand of FIG. 3(a) after a player has selected cards to hold and the remaining cards have been discarded;

FIG. 3(c) illustrates the hand of FIG. 3(b) after replacement cards have been dealt to complete the hand; and

FIG. 4 is a flow diagram of a method of playing a game in accordance with one embodiment of the invention.

### DETAILED DESCRIPTION OF THE INVENTION

The invention is a gaming system and a method of playing a game. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

The invention comprises a method of playing a game including the opportunity for a bonus win, preferably funded from a progressive pool, and apparatus, including gaming machines and/or systems, for presenting the game. Additional aspects of the invention comprise a method and system for determining the amount of a bonus win or award.

One or more embodiments of the invention comprise methods of presenting and playing a game. In one embodiment, one or more variations of a game of the invention are presented or played on a gaming machine. One embodiment of the invention comprises a gaming machine and/or gaming system for presenting one or more variations of a game of the invention.

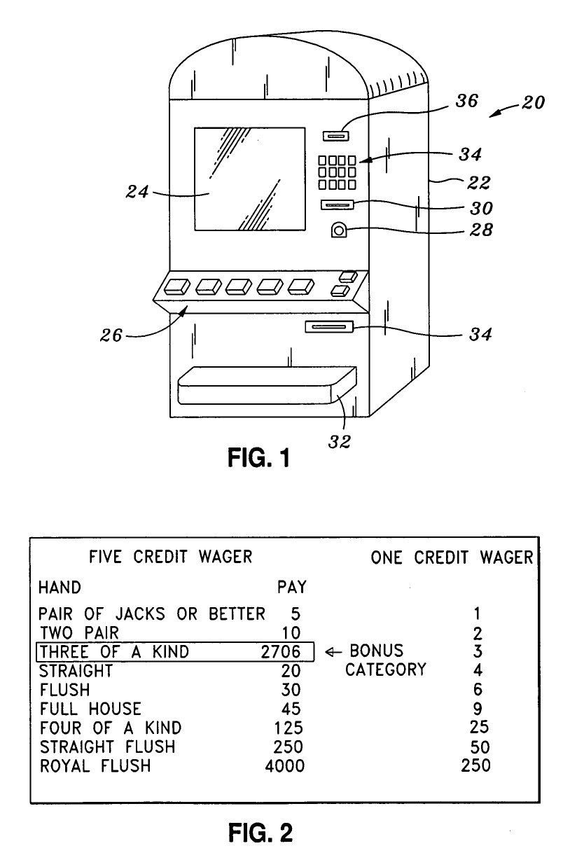

Referring to FIG. 1, a gaming device or machine 20 includes a housing 22 containing or supporting various components. The gaming machine or device 20 is, either alone or in combination with other devices, preferably configured to present a game, such as a game of the invention. It will be appreciated that the housing 22 may have a variety of shapes and configurations. For example, the gaming machine 20 may be configured as an “upright,” “bar-top” or “slant” style gaming machine, which configurations are well known in the industry.

As illustrated, the gaming machine 20 includes means for displaying symbols or indicia utilized in the play or presentation of a game. In a preferred embodiment, the gaming machine 20 is configured as a “video” type machine, in which game information is displayed on at least one display 24. In a preferred embodiment, the display 24 is a video display. The display may be of a variety of types now known or later developed, such as DLP, CRT, plasma, LCD or others.

The gaming machine 20 preferably includes one or more player inputs which permit the player to interact with the gaming machine 20. In the embodiment illustrated, the gaming machine 20 includes a plurality of push-buttons 26. The function to which each button is linked may vary, depending at least in part upon the particular game which the machine 20 is presenting or is configured to present. For example, as described below, the buttons 26 might include a “deal” button, one or more “hold” buttons, a “bet one” button, a “bet max” button, and a “cash out” button, among others.

A wide variety of other inputs may be provided, varying both in form and function. For example, in one embodiment, the display may be configured as a “touch screen” type display. Other inputs, such as a rotatable arm, joysticks, keyboards or keypads, or other inputs may be provided. Each input preferably provides input, such as by way of an electrical signal, to the gaming controller or other game content generating device. In that manner, game play is interactive.

In one embodiment, the gaming machine 20 is configured to present a game only upon a player placing a bet, wager, or other payment. Thus, the gaming machine 20 may include means for accepting value, and preferably, monetary value. As illustrated, the gaming machine 20 may include a coin acceptor 28. The coin acceptor 28 may be configured to accept coins of one or more denominations. A coin sorter, coin hopper and other coin holding and processing devices may be located in the housing 22 of the gaming machine 20.

The gaming machine 20 may also or alternatively include a bill validator 30. The bill validator 30 may be configured to accept paper money of one or more denominations. A bill stacker and other bill processing and storage devices may be located in the housing 22 of the gaming machine 20.

The gaming machine 20 may also or alternatively include a ticket reader, smart card, credit card or other media acceptor/reader. Such devices may be utilized to obtain information regarding value, such as credit card account information or bar-coded ticket value. In one embodiment, the ticket reader may be combined with the bill validator 30.

When value is provided to the gaming machine 20, the gaming machine 20 may be configured to display information regarding the provided value, such as in the form of “credit” information. This information may be displayed, for example, on a display of the gaming machine or one associated therewith.

The player may utilize inputs to place a wager, bet or provide payment to play a game. For example, a player may depress a “bet one” or “bet max” button to bet or wager one or more credits.

In one embodiment, the gaming machine 20 is configured to award winnings for winning outcomes of games played. The winnings may be paid or provided to the player in a variety of manners. In one embodiment, awards may be indicated in the form of credits. Thus, when a player wins, the total number of credits belonging to them is increased, and the increased amount may be displayed to the player. The player may utilize the awarded credits to play future games.

In another embodiment, the player may be awarded money, or may convert credits to money. As illustrated, the gaming machine 20 may include a coin tray 32 into which coins may be dispensed. The coins may represent a specific award. Alternatively, the player may utilize a “cash out” button or input and be paid the value of their credits in the form of coins.

Other forms of payment may be provided, such as by issuance of a ticket which represents value. As illustrated, the gaming machine 20 includes a ticket printer 34 for printing and dispensing a medium bearing information regarding value.

Non-monetary prizes may also be awarded. For example, credits may be redeemed for prizes or a ticket or tickets may be redeemed for specific prizes or general prizes. In other embodiments, game play may be for entertainment purposes only and no prize or award may be won or awarded. In one embodiment, a player may win points which the player can accrue and use, such as for free game play. In another embodiment, no payment need be provided. For example, the game may be played for recreational purposes only. In other embodiments, points may be awarded, the points having no “value,” except to provide the player an indication of the level of success of play of the game. Such a level of points may be compared, for example, to the level of points achieved by other players.

Preferably, means are provided for controlling the operation of the gaming machine 20, such as the content displayed by the display 24. In one embodiment, that means comprises a gaming controller. The gaming controller may be configured to track game credits (including value provided to the gaming machine and bets placed), generate and/or display game symbols or indicia and determine game outcomes. In one embodiment, a gaming controller includes a processor and a memory. The memory stores software which is executed by the processor. In one embodiment, the gaming controller is located inside of the housing 22 of the gaming machine 20.

In another embodiment, the operation of the gaming machine 20 may be controlled in whole or in part from a remote location, such as a remote server. For example, game data may be generated remotely and be transmitted to the gaming machine 20 for display. The game data may then be downloaded to the gaming machine 20 via a wired or wireless communication link.

In one embodiment, the gaming machine 20 may be associated with a player tracking system. This system may include a card reader 34 for reading player information from a card or other media, and a keypad 36 for accepting a player's passcode. Such systems are well known and thus will not be described herein in detail.

The gaming machine 20 illustrated and described is just one embodiment of a device which may be used to present a game in accordance with the invention. Other devices may be utilized. For example, the gaming machine 20 may also comprise a computing device, such as a laptop or desktop computer. Game information may be transmitted via a communication link to a remote player. The communication link may include, for example, the Internet. The game information may be utilized by the remote player's computer, such as by displaying game information on an associated screen. A player may provide input via a keyboard, mouse or other input device.

Various aspects of the games of the invention may be presented at other than a gaming machine. For example, as described below, various features of the invention may be implemented in conjunction with a table game.

In one variation, the gaming machine 20 may be configured as a “slot” or “reel” type gaming machine. In such a configuration, the gaming machine 20 may include one or more reels comprising bodies having one or more indicia or symbols printed thereon. The reels may have a number of positions or locations which bear or do not bear (i.e. comprise a “blank” position) indicia. The indicia or symbols which are borne by the reels may vary.

In such a configuration, the various combinations of indicia displayed by the reels preferably have significance to or relate to the outcome of a game presented at the machine 20. For example, certain combinations of indicia may comprise a non-winning combination. Preferably, one or more combinations of the indicia when displayed as a result of a spin of the reels are designated as a winning combination of indicia. The number of winning combinations may vary dependent upon the desired payout or winning percentage to the players as compared to that which is retained by the game operator. Means are provided for rotating the reels. In one or more embodiments, the means may comprise a mechanical linkage associated with a spin arm, with movement of a spin arm (a “pull”) by a user causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. As is well known, the combinations of reel positions and their odds of hitting are associated with the controller, and the controller is arranged to stop the reels in a position displaying a combination of indicia as determined by the controller based on the combinations and odds. The principal of such an arrangement is described in U.S. Pat. No. 4,448,419 to Telnaes, which is incorporated herein by reference.

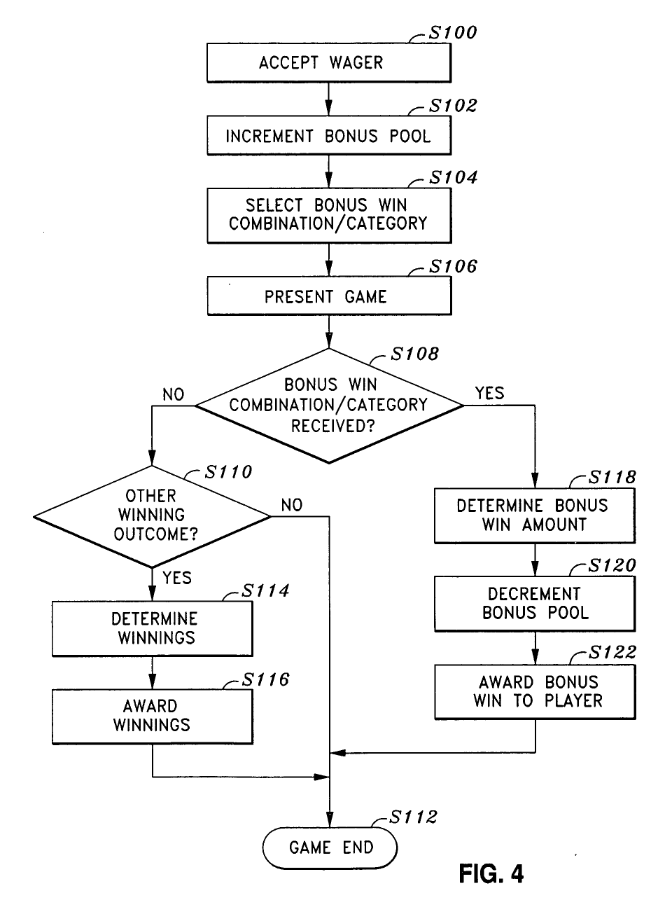

One embodiment of a game of the invention will be described with reference to FIG. 4. As indicated, in a preferred embodiment of the invention, the game is played as a wagering game. As such, in a step S100, a bet or wager is accepted from the player. In the case of a gaming machine such as that illustrated in FIG. 1, monetary value may be provided by currency, coins, tickets, credit/debit card or other means. A specific wager may be presented by input, such as by pressing a “bet one” or “bet max” button.

In a preferred embodiment, the game involves the opportunity to win a bonus win or award. In one embodiment, as described below, the opportunity to win a bonus award depends upon one or more criteria, such as whether a player places a wager of a particular size and whether the player receives a particular game outcome. The bonus win or award may be referred to as a jackpot, jackpot winning or jackpot award (or other terminology), since, in a preferred embodiment, the size of the bonus award has the opportunity to be much larger than a normal payout or award for a particular result of the game.

In one embodiment, the bonus win is paid, at least in part, from a fund or pool. Wagers are preferably used, at one or more times, to fund the pool. In a preferred embodiment, the pool is configured as a progressive pool. As such, the size or value of the pool, and thus the associated potential bonus award, increases over time (preferably, based upon game play frequency). Thus, in a step S102, when a bet or wager is accepted, the pool is preferably incremented. The amount by which the pool is incremented may vary, as described in detail below.

In a step S104, at least one, and preferably just one, bonus win combination or category is selected. In one embodiment, the game of the invention has numerous possible outcomes. In a preferred embodiment, one of the possible outcomes is selected as a combination, category, outcome or result which, if received, entitles the player to a bonus award. The bonus win combination or category may be of a variety of types, such as combinations of cards (as in video poker), combinations of symbols (as in “slot” type games, sets of number or matching symbol patterns (as in bingo or keno)), and thus may comprise hands, symbol sets or the like.

In one embodiment, out of the various possible outcomes, a plurality of outcomes are designated potential winning outcomes. Preferably, one of those potential winning outcomes is selected to be the bonus win combination or category. For example, in the game of video poker where a Pair of Jacks or better and all higher ranked hands are designated winning poker hands, the bonus win combination or category is preferably selected from those hands.

Preferably, the bonus win combination or category is randomly selected so that it has the potential to comprise a different winning combination each time the game is played. Thus, for example, in the case of the play of video poker, the bonus win combination or category may comprise a Full House for one game, and a Flush for the next game.

Of course, other means may be provided for selecting or designating the bonus win combination or category. For example, the selection of potential bonus win combinations or categories may be weighted, so that certain combinations, categories or other outcomes are selected more often than others as the bonus win combination or category.

In a step S 106, the game is presented to the player. The game which is presented may vary. As described below, in one preferred embodiment, the game is a game of video poker presented on a gaming machine such as that illustrated in FIG. 1 and described above. The game may be other types of games, such as “slot” games, other types of card games, bingo or keno, and others. As indicated above, the games may be presented on gaming machines, at tables or using a variety of other devices.

Of course, depending upon the game which is presented, a variety of events may occur. Those events may include the presentation of game indicia and input from a player, such as regarding cards to be held and discarded.

In a step S108, it is determined if the bonus win combination or category was received as a result of the presentation and/or play of the game.

In a step S110, if the outcome of the game was not the bonus win combination or category, then it is determined if the outcome of the game was another winning outcome. If not, then the game preferably ends at step S112.

If a winning outcome other than the bonus win combination or category was received, then in a step S114 it is determined what winnings are associated with that outcome. In a step S116, those winnings are awarded to the player. For example, the winnings may comprise a plurality of credits. Those credits may be awarded to the player. The player may then collect their winnings, such as by “cashing out” and having their credits converted to coins. Alternatively, the player might be issued a ticket which represents their winnings (and any accrued placed value or other winnings).

If in step S108 it is determined that the outcome of the game was the bonus win combination or category, then in step S118, the bonus win or award which is associated with that wining result is determined. A preferred embodiment of such a method is described in more detail below. In one embodiment, the bonus win which is awarded to the player comprises at least a portion of the bonus pool. As described below, in a preferred embodiment, the bonus or jackpot win or award comprises a base award component and, potentially, a progressive award component.

In a preferred embodiment, at least a portion of the bonus win is funded by the pool. As such, in a step S120, the value of the bonus pool is preferably adjusted after the bonus win is awarded to the player. Generally, the size of the bonus pool is reduced by the size of the award therefrom.

In a step S122, the bonus win is awarded to the player. As described above, this may be accomplished in a variety of ways, including by issuing credits to the player. In another embodiment, where the bonus win is large, the machine may send a message to the game operator indicating that the bonus win has been awarded. The operator may then travel to and issue the award to the player, such as via a written check.

A variety of alternate configurations are possible. For example, the game may not include any winning outcomes or combinations other than the bonus win combination or category. In such event, steps S110, 114 and 116 may not exist. Of course, the method of game play might include additional steps. For example, in one embodiment, the game might include a bonus event. Thus, the method of play might include the steps of presenting the bonus event and determining the results of the event. For example, the game might comprise a game of slots where, if certain results are obtained, the player may spin a wheel for an additional payout or win. The steps may also be performed in other sequences than as specifically illustrated in FIG. 4.

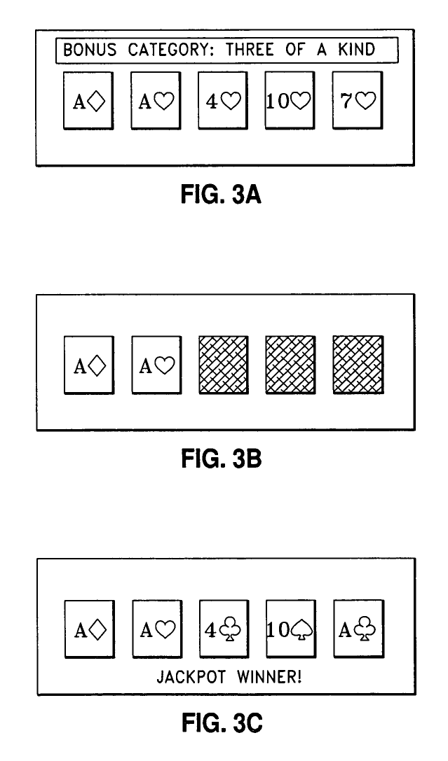

An example of an embodiment of game play will now be described with reference to FIGS. 2 and 3(a)-(c). In this embodiment, the method of game play involves the play of a game of video poker. In a preferred embodiment, the game is five card draw-type video poker.

As is known, in this game, a player is dealt five cards. The player may then select none, one or more, or all, of the cards to be held. Those cards which are not held are discarded. Replacement cards are then dealt to complete the hand of five cards. That hand is then evaluated to determine if it is a winning outcome. It will be appreciated that the term “dealt” herein may comprise the step of displaying the image(s) of the card(s).

As is known, in this game, there are a large number of possible card combination outcomes from the final set of five cards. Generally, one or more of those outcomes are designated “winning” outcomes. FIG. 2 illustrates a paytable for a variation of the game known as “Jacks or Better.” In this game, combinations of cards which comprise at least a Pair of Jacks (or a higher poker ranking) are designated winning outcomes or combinations, when considering standard poker hand rankings (which are well known to those of ordinary skill in the art).

In this embodiment, a Pair of Jacks or better (i.e. a pair of Queens, Kings or Aces) is designated a winning combination having a first payout or award. Similarly, hands of Two Pair, Three of a Kind, a Straight, a Flush, a Full House, a Four of a Kind, a Straight Flush, and a Royal Flush, are also designated winning combinations and have associated payouts or awards. The payout or award for the various winning hands may vary, as may the card combinations which are designated winning combinations.

In accordance with the invention, after a player has placed a wager (if required), one of the winning combinations is selected to be the bonus win combination or category. Preferably, this selection is made randomly. As one example, as illustrated in FIG. 2, the potential combination “Three of a Kind” has been selected.

Preferably, the bonus win combination or category which has been selected is made known to the player. As illustrated in FIG. 2, such a designation may be made apparent as part of the display of the paytable. Alternatively, or in addition, as illustrated in FIG. 3(a), the selection may be made known by display in association with the presentation of the game. Of course, other means may be utilized to make the player aware of the bonus win combination or category which has been selected. For example, such might be displayed on a secondary display, announced by an audio announcement or the like.

In one embodiment, the bonus win or award associated with the bonus win combination or category, if received, may also be displayed. As illustrated in FIG. 2, the paytable has been configured to display the payout or award associated with each winning combination, including the bonus win combination or category. In this case, while the normal payout for a Three of a Kind hand (for a maximum five (5) credit bet) may be 15 credits, because that combination has been selected as the bonus win combination, the paytable reflects the current payout for that outcome as the bonus or jackpot win of 2706 credits. Various methods for calculating or determining a bonus or jackpot award are described in more detail below.

Play of the game proceeds as is known in the art of video poker. Referring to FIG. 3(a), a set of five cards are dealt or displayed to the player. In this case, the player has received the cards A⋄, A [symbol] , 4 [symbol] , 10 [symbol] , and 7 [symbol] .

In the game of draw video poker, the player is permitted to select none, one or more (or all) of the cards to be held, and those which are not held to be discarded and replaced. In this example, as illustrated in FIG. 3(b), the player has elected to hold the A [symbol] and A⋄. The remaining cards have be discarded.

Next, as illustrated in FIG. 3(c), replacement cards are dealt or displayed to those which were discarded. In this case, replacement cards 4 [symbol] , 10 [symbol] , and A [symbol] have been dealt or displayed. The resulting hand is thus A⋄, A [symbol] , 4 [symbol] , 10 [symbol] , and A [symbol] . This hand comprises a Three of a Kind. Thus, upon evaluation, it is determined that the bonus win combination of Three of a Kind has been received by the player, and the player is preferably awarded the bonus or jackpot winnings associated with that result.

Various aspects of the invention will now be appreciated. One aspect of the invention is a game which has many potential outcomes, one of which is selected to be a special outcome having a special winning result. In the preferred embodiment, that result is a result entitled to a larger than normal award or winning.

Another aspect of the invention is a game in which the potential larger than normal bonus win is associated with different results of each game. As described, in the preferred embodiment, the bonus win combination or category is preferably randomly selected for each game. Thus, each time the player plays the game of the invention, the outcome which is designated the bonus win combination or category may change.

The game as described provides the opportunity for substantial excitement. In particular, each time the player plays the game, they know a bonus win combination or category will be selected, and they will have the opportunity to win the bonus if they obtain that combination.

Moreover, in the game such as that just described, knowledge of the bonus win combination or category may add substantial excitement and interest to the game by permitting the player to choose a game play strategy to capitalize on the opportunity to win the bonus award associated with the bonus win combination or category. In the example illustrated in FIG. 3(a), the player was one card short of a Flush, and one card short of a Three of a Kind when the initial set of cards were dealt. Under normal circumstances, if the player received a Flush, the payout would be larger than that for a Three of a Kind. However, in this example, Three of a Kind was selected to be the bonus winning outcome or combination. As a result, the player has the opportunity for a much larger win by playing for the Three of a Kind result rather than a Flush. As illustrated in FIG. 3(b), the player thus kept the pair of Aces in attempt to obtain the Three of a Kind result.

Additional embodiments of the invention comprise methods for creating a bonus fund or pool, and awarding a bonus win, including determining the size of the bonus win which is to be awarded. These methods have particular applicability to the games of the invention. As described below, however, these methods and systems may have applicability other games and even other types of events.

One aspect of the invention is a method for determining the size or value of a bonus win to be awarded. In one embodiment, the method comprises determining the size of a bonus win based upon one or more factors such as the size or denomination of the wager which is placed to play the game and/or the size or magnitude of the normal payout or probability of receiving a particular winning outcome.

In one embodiment, a bonus pool is seeded with a certain amount of funds, such as $10,000.00. Each time a game is played, a portion of one or more the bets, and preferably a portion of the total credits bet, is added to the pool. In one embodiment, a portion (such as a percentage) of each bet is allocated to the pool. In another embodiment, the pool is incremented when a player places a bet of a certain size, including a bonus wager. For example, a gaming machine may offer base game play with wagers of one (1) to five (5) credits (such as illustrated in FIG. 2). If the player places a wager of six (6) credits, the bonus feature may be activated, with all or at least a portion of the additional credit/wager being allocated to the pool. In other embodiments, a player may be permitted to participate in the bonus event by placing a smaller wager, such as a single credit, along with an additional bonus wager.

In a preferred embodiment, when the bonus win is awarded, the pool is reduced by the magnitude of the bonus win amount. Later calculations of the bonus win then utilize the adjusted pool amount or value (as further adjusted by additions to the pool from newly placed wagers).

As indicated above, in various embodiments, a bonus win may be awarded as a result of game play. A bonus win might be awarded based upon other criteria or circumstances, such as in a player tracking environment as part of a complimentary award.

In a preferred embodiment, at least a portion of the bonus pool is awarded. In one embodiment, the portion of the pool which is awarded depends upon the size of the player's wager and/or the winning outcome. Preferably, a single pool is funded by play of games based on wagers of different denominations, whether played at a single or a plurality of gaming machines, and bonus wins or awards are paid from that single pool.

In one embodiment, the size of the bonus win depends upon the denomination of the wager and/or the size of the wager which is placed, preferably in relation to the maximum denomination or maximum wager. For example, in one embodiment, a player who places a $0.05 wager and obtains a bonus win combination or category is preferably awarded a smaller bonus award and, in particular, a smaller portion of the bonus pool, than a player who places a $1.00 wager and receives the same bonus win combination or category.

In one embodiment, the size of at least a portion of the bonus win is generally proportionally dependent upon the size of the wager. If a player places the maximum wager, then the bonus win is not reduced based upon the wager size. If the player places a wager which is one-half of the maximum wager, then the size of at least a portion of the bonus win or award is reduced.

In one embodiment, the size of at least a portion of the bonus win or award is dependent upon the outcome of the game. In a preferred embodiment, the bonus win is dependent upon the statistical probability of receiving that outcome. Thus, as one example, a player who obtains a bonus win combination or category which has a high probability of occurring (e.g. a Pair of Jacks) will be awarded a smaller bonus award than a player who receives a bonus win combination or category which has a low probability of occurring (e.g. a Four of a Kind).

In one embodiment, the normal payout or win for the bonus win combination or category as compared to the highest payout for all potential winning amounts is used, at least in part, to determine the size of the bonus win. Preferably, this comparison of payouts is made based upon payouts for a single credit wager or other minimum wager. For example, in the case illustrated in FIG. 2, if the bonus win combination is Two Pair, and the bet one or minimum wager payout for this winning combination is 2, and the bet one or minimum wager payout for the highest paying winning combination (a Royal Flush) is 250, and thus the payout scaling ratio is 2/250. Of course, other methods may be employed for proportionally scaling the bonus award. For example, the scaling ratio could be based upon the true odds of receiving the winning combination compared to the least likely winning combination (e.g. a comparison of the odds of receiving Two Pair, 0.047539016 vs. the odds of receiving a Royal Flush, 0.000001539).

In one embodiment, the bonus win which is awarded has two components: a base award component or portion, and a progressive award component or portion. Preferably, both components of the bonus win are funded or paid from the pool. As indicated above, the amount of the pool which is awarded may be dependent upon factors such as the size of the wager and/or the bonus winning combination or category which is received.

In one embodiment, the portion of the pool which is awarded as the base award component or portion preferably reflects the odds of the bonus win combination or category being achieved relative to all of the potential winning combinations. Thus, in a preferred embodiment of the invention, the size of the base award is actually larger than the normal payout for a particular winning combination.

For example, as described in the example below, and referring to the paytable illustrated in FIG. 2, only one bonus win combination or category can be received from a total of nine possible winning combinations. Out of those possible winning outcomes or combinations, only eight of the outcomes or combinations pay or return more than the original wager. Thus, the player has only a one (1) in eight (8) chance to receive the bonus win combination or category from the possible winning outcomes which return more than the base wager. Thus, the player's base award component is preferably paid eight (8) minus one (1), or seven (7) times the single credit bet or minimum bet payout for that bonus win combination or category.

The portion of the pool which is awarded as the progressive award component or portion preferably reflects the proportional relationship of the denomination of the player's wager to the maximum denomination wager, and the proportional relationship of the probability of receiving the outcome relative to the least likely winning outcome. As indicated, in a preferred embodiment, the later probability represented as the bet one or minimum wager payout for the bonus win combination or category compared to the bet one or minimum wager pay for the highest possible payout combination or category.

In one embodiment, the jackpot award associated with a particular selected bonus win combination or category is determined in accordance with the following:
(1) Bonus or Jackpot Win=Base Award Component+Progressive Award Component
(2) Base Award Component=(Number of Eligible Winning Outcomes−1) * The Normal Payout for the Winning Outcome Based Upon a One Credit or Other Minimum Wager * Denomination of Wager
(3) Progressive Award Component=((Pool Size−Base Award)−Progressive Threshold for Pool) * (Normalized Denomination/Maximum Calculation Denomination) * (Normal Payout for Winning Outcome Based Upon a One Credit or Other Minimum Wager/Maximum Possible Award for a One Credit or Other Minimum Wager)

Where:
(A) The Number of Eligible Winning Outcomes is the number of outcomes of the game (such as categories or combinations) for which a win which is greater than the amount of the wager is yielded. For example, in the configuration illustrated in FIG. 2, if the wager is six (6) credits (e.g. five credit base bet plus an additional single credit bonus activating wager), then the Number of Eligible Winning Outcomes is eight (8) (comprising Two Pair, Three of a Kind, etc. and excluding a Pair of Jacks or Better).
(B) The Normal Payout for the Winning Outcome is the award which is yielded for the winning outcome when a single credit or other minimum wager is placed. For example, referring to FIG. 2, the payout when a single credit is wagered is two (2) for the winning outcome Two Pair. In the case where wagers may be placed as credits ranging from a single credit to multiple credits, this value may be referred to as the “bet one pay” for the winning outcome.
(C) The Denomination is the denomination or value of each credit being wagered. For example, a credit may represent $0.05, $0.10, $0.25, $1.00 or other amounts.
(D) The Normalized Denomination is the lesser of the Denomination and the Maximum Calculation Denomination.
(E) The Maximum Calculation Denomination is the largest denomination which may be played, and thus used in the Bonus Award calculation.
(F) The Pool Amount is the current value of the pool or fund from which the bonus is to be awarded.
(G) The Progressive Threshold is, in a preferred embodiment, a value of the bonus pool below which a progressive award component is no longer available, and any bonus win has only a base award component.

An example of these calculations will now be provided. Assume that the current Pool Amount is $20000.00, and the selected progressive threshold for the pool is $10000.00. Assume that the minimum wager denomination is $0.25 and the maximum wager denomination is $1.00. Assume that the selected jackpot winning combination is a Straight Flush, which has a bet one or minimum wager payout (which may be referred to as a “base” or “normal” payout) of fifty (50) credits (as illustrated in FIG. 2). As also illustrated in FIG. 2, the highest pay for any winning combination based upon the minimum wager is 250 credits (for a Royal Flush). Assume that the player is playing video poker with the potential winning combinations illustrated in FIG. 2, and has placed a $0.25 denomination wager.

The Bonus Win would be:
(A) The Base Award Component=(Number of Eligible Winning Combinations−1)*Normal Payout (i.e. Bet One Payout) for Winning Outcome*Denomination=(8−1)* 50 * $0.25=$87.50
(B) The Progressive Award Component=((Pool Amount−Base Award Component)−Progressive Threshold)*(Normalized Denomination/Maximum Calculation Denomination)*(Normal Payout (i.e. Bet One Payout) for Winning Outcome/Maximum Payout for Any One Credit or Other Minimum Wager=((20000−87.5)−10000)*(0.25/1)*(50/250)=$495.63
(C) Bonus Win=Base Award Component+Progressive Award Component=$87.5+$495.63=$583.13
(Compared to a maximum wager payout of 50 credits, or $62.50 when the game is played with no bonus win).

It will be appreciated that if the player had placed a wager of a larger denomination or had been playing for (and received) a bonus win combination or category having a lower frequency of occurrence, then the amount of the bonus win would have been higher. In particular, the size of the award was a fraction of the possible award, based upon the ratio of the size of the denomination of the wager to the largest possible denomination of the wager (i.e. $0.25/$ 1.00). If the denomination of the wager had been larger, this fraction would be larger—i.e. if the player placed a wager with the largest denomination, then the fraction would have been one (1) (i.e. $1.00/$1.00).

Similarly, the size of the bonus win would be larger if the player was playing for, and received, a bonus win combination or category which had a higher normal or “bet one” payout (generally symbolizing the lower odds associated with receiving that combination). For example, if the selected bonus win combination or category was a Royal Flush and the player received or won that combination, then the fractionalized amount of the pool which was award would be (250/250) instead of (50/250).

It will thus be appreciated that if the player had received a Royal Flush bonus win combination or category having placed a $1.00 denomination wager, the player's bonus win would be:
Base Award Component=(8−1)*250*1=$1750.00
Progressive Award Component=((20000−1750−10000)*($1.00/$1.00)*(250/250)=$8,250.00
Bonus or Jackpot Win=$1750.00+$8250.00=$10,000.00

As indicated, in one embodiment, the base award component comprises a base amount, multiplied by a multiplier, preferably multiplied by a denomination of the wager. In a preferred embodiment, the base amount comprises the payout or pay amount for the bonus win combination or outcome when a wager of a single credit or other minimum wager is placed. The base amount may comprise other values, however, such as a payout for another size wager. The base amount might also be selected based on other criteria, such as by being a set amount or normal payout plus or minus a value. As also described, in a preferred embodiment, the multiplier comprises a value of one less than the number of eligible winning outcomes which return more than the player's wager. The multiplier could be arbitrarily or randomly selected or chosen. The multiplier may comprise a whole and/or fractional value. As other examples, the Number of Eligible Winning Combinations may be other than the number of paylines or combinations which return more than the wager. For example, the Number of Eligible Winning Combinations might be an even lesser number, such as only those paylines which return a large winning.

In one embodiment, it is also possible for the base award component to comprise a set value. For example, a base award component may be determined corresponding to each possible bonus win combination or category which may be selected. The base award component for those possible combinations or categories may differ based upon the size of the player's wager or other factors. These values may be associated with a look-up table, for example, so that when a bonus win combination or category results, the base award can simply be obtained from the table.

As indicated, the bonus win may be funded from more than one pool or fund. For example, in one embodiment, a base award fund or pool and a progressive award fund or pool may be provided. The base award fund may be funded until a progressive threshold is reached. Thereafter, funds may be placed into the progressive award fund or pool. In this instance, the progressive award is only awarded if there are funds in the progressive award pool. Otherwise, only a base award is awarded. In this configuration, the progressive award may simply comprise a portion of the progressive award pool (such as a proportion thereof depending upon the denomination of the wager and/or probability of outcome, and possibly reduced by the value of the base award component).

As described above, in one embodiment, the value of the bonus win for the bonus win combination or category may be displayed to the player during the game, such as when the bonus win combination or category is selected. In one embodiment, the method described above may be utilized to calculate that winning amount. In particular, once the bonus win combination or category is selected and the player's wager has been placed, it is possible to calculate the bonus win if the player receives that bonus win combination or category.

As also described above, however, in a preferred embodiment, the actual bonus orjackpot win which is awarded to a player may not be calculated until after the outcome of the game is known. In particular, in one embodiment of the invention, the bonus pool may be funded by wagers placed by players of either a single gaming machine or multiple gaming machines. For example, multiple gaming machines may be linked or associated in a network type environment. Wagers placed at any and/or all of those machines may increment the bonus pool. In one embodiment, the multiple machines may be associated with a server or other central computing device which manages the pool. In such an arrangement, between the time when a player places their wager and the outcome of the game is determined, the bonus pool may be incremented based upon the wagers of other players at other gaming machines. In addition, before the player plays the game, the outcome of a game at one of the other machines might result in an award of the bonus win, causing the bonus pool value to be decremented. As such, in one embodiment, the size of the bonus win is only determined when the game outcome is known. Of course, in other embodiments, the bonus win could be determined at the time the player's wager is placed, or at other times.

As indicated, in a preferred embodiment, a player plays for a single bonus win combination or category. In one embodiment, there might be more than one bonus win combination or category. For example, in one embodiment, if a player places a wager of a first size (such as including a first bonus wager amount), a single bonus win combination or category may be designated. If the player places a wager of a second size (such as a larger wager including both a first and a second bonus wager), more than one (such as two) bonus win combinations or categories may be designated.

In one embodiment, it is also possible to designate as a bonus win combination or category an outcome which is not otherwise a winning result or which is a more specific than one of the already defined winning outcomes. For example, in the game of video poker where a Pair of Jacks or better is designated a winning outcome, a bonus win combination or category might be defined as a Pair of Tens. Alternatively, where the winning outcomes comprise a Four of a Kind, the bonus win combination or category might be specifically defined as “Four Aces.”

As indicated, the invention may be practiced where the bonus win is other than as specifically described above. For example, the bonus win may simply comprise the base award, or might comprise the base award coupled with an additional award other than the bonus award.

It will be appreciated that the above-described method thus has particular applicability to an award of a bonus associated with a game which may have either or both of different sized denomination wagers and probabilities of winning outcomes (and thus payouts therefor). This includes, for example a gaming machine which may accept wagers of different denominations and/or systems including different machines which may accept wagers of different denominations.

The method has applicability to a situation where the bonus is awarded from a fund other than a progressive pool. For example, a bonus fund may be set and seeded to a constant value, such as $10,000,00. The amount of that bonus fund which is awarded may be calculated as described above, where the size of the bonus depends upon the size of the wager or the denomination thereof and/or the probability of receiving the outcome (as, for example, reflected by the base payout for that winning outcome).

The method has applicability to games other than that described above, including games involving other than the play of video poker. For example, the method could be utilized to determine the size of a bonus or jackpot award in the game of slots, keno or bingo, among others.

As indicated, the various games and methods of the invention may be implemented in conjunction with table and other games. For example, a bonus win may be awarded when a player places an appropriate wager and receives a bonus win combination or category playing a game of poker with cards at a gaming table. In one embodiment, wagers may be tracked, such as by an electronic coin counter. Bonus win combinations or categories may be selected and displayed, along with bonus wins, at a display associated with the gaming table.

In accordance with variations of the invention, a bonus win may be awarded which has only a base award (and no bonus award) component, or only a bonus award (and no base award) component. In this regard, individual aspects of the invention may be practiced alone or in various combinations, including with other game elements.

One aspect of the invention which will now be appreciated is the creation of a bonus pool and management of the bonus pool in funding payouts. The bonus pool is funded, at least in part, and preferably completely, from player wagers. Preferably, the player wagers which fund the pool are bonus wagers which exceed a wager amount for play of the game. The bonus pool can be associated with a single gaming machine (or other game, such as a table game), or be associated with a plurality of gaming machines, such as administered by a central computer.

One aspect of the invention is a method of “managing” the bonus pool, including awarding bonus wins from the pool, including a method of determining the value or amount of the bonus win. One aspect of the invention is a method in which a bonus win has two components, a base award component and a progressive award component. In the preferred embodiment, the progressive award component, which comprises a percentage of the pool, is not awarded if the bonus pool amount falls below the progressive threshold.

This configuration has the significant advantage of stabilizing the bonus pool. Because the base award component is only a portion of the bonus win which is awarded from the bonus pool, if the bonus pool drops below the progressive threshold, the bonus win comprises only the base award component. This prevents the bonus pool from being prematurely depleted.

Thus, as one aspect of the invention, there is a method of awarding a bonus win from a pool in a manner which ensures that the size of the pool remains sufficiently large to fund bonus wins which are larger than the normal wins or payouts for a particular outcome.

As indicated above, in one embodiment, the bonus win combination or category is randomly selected. In other embodiments, the bonus win combination or category may be selected based upon a variety or other criteria. For example, the bonus win combination or category may be selected so as to manage the size of the bonus pool to prevent its depletion. For example, after a maximum bonus win (such as for a Royal Flush, maximum denomination bet, as described above), one or more bonus win combinations or categories may be selected which offer a lower bonus win, thus allowing an opportunity for the bonus pool to be funded back to a higher level.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method of playing a game comprising the steps of:
providing at least one bonus pool;
accepting a wager from a player for entitlement to play said game, said game having a plurality of possible winning outcomes from a group of all possible outcomes;
randomly selecting one of said plurality of possible winning outcomes;
designating said selected winning outcome as a bonus winning outcome;
presenting said game to said player;
determining the outcome of said game; and
awarding at least a portion of said at least one bonus pool to said player if said outcome of said game is said bonus winning outcome.

2. The method in accordance with claim 1 wherein said game comprises video poker.

3. The method in accordance with claim 1 wherein at least a portion of said wager is associated with said at least one bonus pool.

4. The method in accordance with claim 3 including the step of incrementing a value of said at least one bonus pool.

5. The method of playing a game of video poker comprising the steps of:
accepting a wager from a player;
incrementing a bonus pool by a value comprising at least a portion of said wager;
randomly selecting as a bonus winning combination a combination selected from the group of winning combinations consisting of: at least a pair, two pair, three of a kind, full house, straight, flush, full house, four of a kind, straight flush and royal flush;
displaying a first set of cards;
permitting said player to select none, one or more or all of said first set of cards to be held;
displaying a replacement card for each card not held;
forming a resulting hand;
determining if said resulting hand comprises said bonus winning combination; and
awarding a bonus win comprising at least a portion of said bonus pool to said player if said resulting hand comprises said bonus winning combination.

6. The method in accordance with claim 5 including the step of reducing said bonus pool based upon said bonus win.

7. The method in accordance with claim 1 wherein said bonus win has a base component and a progressive component, and wherein said progressive component is not awarded if said bonus pool falls below a progressive threshold.

8. The method in accordance with claim 1 including the step of awarding an award if said resulting hand comprises a winning combination other than said bonus winning combination.

9. A method of determining the size of a bonus win award to be paid to a player of a game who receives a particular winning outcome comprising the steps of:
determining a base award component, said base award component comprising a multiplier of a base payout for said winning outcome multiplied by a denomination of a wager placed by said player to play said game;
determining a progressive award component, said progressive award component comprising a bonus pool value, less said base award component, multiplied by a ratio of the denomination of the player's wager to a maximum denomination of wagers which may be placed, multiplied by a ratio of the base payout for said winning outcome to the largest base payout for any possible winning outcome; and
determining said bonus win, said bonus win comprising the sum of said base award component and said progressive award component.

10. The method in accordance with claim 9 wherein said multiplier comprises a number which is at least one less than the number of possible winning outcomes having a payout which exceeds the player's wager.

11. The method in accordance with claim 9 wherein said bonus pool value comprises a current bonus pool amount less a progressive threshold.

12. The method in accordance with claim 9, wherein said base award component is also paid from said bonus pool.

13. The method in accordance with claim 9 including reducing the size of said bonus pool by the value of said jackpot award.

14. The method in accordance with claim 9 wherein said base payout for said winning outcome comprises a payout for said winning outcome when a wager of a single credit is placed.

15. The method in accordance with claim 9 wherein said largest base payout for any possible winning outcome comprises the largest payout for any winning outcome when a wager of a single credit is placed.
